(19) United States
(12) Patent Application Publication
(10) Pub. No.: US 2026/0024545 A1
(43) Pub. Date: Jan. 22, 2026

(54) NEURAL NETWORK BASED SIGNAL PROCESSING

(71) Applicant: DOLBY INTERNATIONAL AB, Dublin (IE)

(72) Inventors: Janusz KLEJSA, Solna (SE); Per Henrik HEDELIN, Göteborg (SE); Lars VILLEMOES, Stockholm (SE)

(73) Assignee: DOLBY INTERNATIONAL AB, Dublin (IE)

(21) Appl. No.: 18/994,017

(22) PCT Filed: Jul. 14, 2023
(86) PCT No.: PCT/EP2023/069703

§ 371 Date: Jan. 13, 2025

Related U.S. Application Data
(60) Provisional application No. 63/391,124, filed on Jul. 21, 2022.

(30) Foreign Application Priority Data
Aug. 2, 2022 (EP) 22188293.9

(51) Int. Cl. G10L 25/30; G10L 19/032

(52) U.S. Cl. CPC G10L 25/30; G10L 19/032

(57) ABSTRACT

A method for processing an input audio signal, comprising conditioning a first neural network system with a representation of the input audio signal to predict a bit-rate reduced representation of a processed input audio signal, the first neural network system being trained to generate a bit-rate reduced representation of a processed version of a given audio signal, wherein the bit-rate reduced representation has a format associated with a pre-defined audio encoding process, conditioning a second neural network system with the bit-rate reduced representation to predict an enhanced representation of the processed audio signal, the second neural network system being trained to generate an enhanced representation of a given a bit-rate reduced audio representation, wherein the bit-rate reduced representation has a format associated with the pre-defined audio encoding process, and transforming the enhanced representation of the processed audio signal into an output audio signal.

### CROSS-REFERENCE TO RELATED APPLICATIONS

This application claims the benefit of priority of the following priority application: U.S. provisional application Ser. No. 63/391,124, filed on 21 Jul. 2022, and European Patent Application No. 22188293.9, filed 2 Aug. 2022, each of which is incorporated by reference herein in its entirety.

### TECHNICAL FIELD OF THE INVENTION

The present invention relates to audio signal processing using generative models involving neural network systems. The signal processing may for example relate to signal enhancement or source separation.

### BACKGROUND OF THE INVENTION

For some time, generative models involving trained neural network systems have been used in various audio signal processing applications. The general approach is that a neural network system is trained using ground truth data, after which the trained model may be used to infer a processed signal. Specifically designed neural network systems have been developed for specific applications, including decoding.

In some signal processing applications, even though it is conceivable to successfully train a neural network to perform the intended signal processing, such a neural network system would become impractically complex. This requires enormous amounts of training data, and also enormous computational resources during inference.

Some attempts have been made to mitigate this problem. In one approach, disclosed e.g. in Jukebox: A generative model for music, Dhariwal et al, 2020, an input signal is first transformed to a vector quantized representation, before being input to a generative model. The inferred signal is then synthesized back to a complete representation. As a result of this approach, the generative model operates in vector quantized space, significantly reducing computational complexity.

### GENERAL DISCLOSURE OF THE INVENTION

A drawback with the approach discussed above, is that the vector quantization (or any other complexity reduction) creates a trade-off between complexity reduction and attainable quality. This trade-off is difficult to optimize. Another drawback is that the vector quantization—which is applied directly to the signal to be processed—may remove some information that is relevant to solving the processing problem, thereby limiting the achievable performance.

The present invention seeks to overcome these problems and provide an improved approach to audio signal processing with neural networks.

According to a first aspect of the invention, this objective is achieved by a method for processing an input audio signal, comprising conditioning a first neural network system with a representation of the input audio signal to predict a bit-rate reduced representation of a processed input audio signal, the first neural network system being trained to generate a bit-rate reduced representation of a processed version of a given audio signal, wherein the bit-rate reduced representation has a format associated with a pre-defined audio encoding process, conditioning a second neural network system with the bit-rate reduced representation to predict an enhanced representation of the processed audio signal, the second neural network system being trained to generate an enhanced representation of a given a bit-rate reduced audio representation, wherein the bit-rate reduced representation has a format associated with the pre-defined audio encoding process, and transforming the enhanced representation of the processed audio signal into an output audio signal.

The processing is thus performed in two stages, with an intermediate processing result which is bit-rate reduced. This intermediate processing result is referred to as a latent signal.

It is important to note that the intermediate processing result (latent signal) has a format which is associated with a pre-defined audio coding process. This means that for a given (known) pair of overall ground truth signals, i.e. original signal and processed (target) signal, also an intermediate processing target for the first stage can be deterministically determined. For example, in the context of a supervised training, the training objective for the first stage can be defined as a function of the network output and an audio-coded target (not an uncoded target). This process facilitates a definition of an audio coded latent that effectively decouples the stages. As a consequence, the neural network systems of each stage can be trained (individually or jointly) using separate loss functions.

Individual training of the two neural network systems has a potential advantage as it may be simpler to carry out, and likely the models implementing the networks can be relatively smaller. Joint training is expected to provide better overall performance, but will likely require larger models and more training data.

During inference, the first network solves the processing task by providing the result in an intermediate representation, while the second network provides the final processing result based on the intermediate representation. The fact that the inference involves two specialized networks has a significant impact on computational complexity (compared to an end-to-end system). The usage of two specialized networks facilitates decomposing the processing problem into subproblems, which can be associated with their respective training objectives. It is expected that a single network solving the processing task in an end-to-end setting would require significantly more trainable parameters, and significantly larger amount of the training data.

Further, the bit-rate reduction (quantization) of the latent, which is performed according to the predefined audio coding process, achieves a trade-off between bit-rate reduction and distortion according to the pre-defined audio coding process. An audio coding algorithm optimizes its bit-rate distortion trade-off in a perceptually optimized way, and its details depend on the coding algorithm. The format of the latent therefore ensures an appropriate trade-off between performance of the processing task performed by the first stage and the performance of the final synthesis task performed by the second stage.

According to a second aspect of the invention, this objective is achieved by a system for processing an input audio signal, comprising a first neural network system trained to generate a bit-rate reduced representation of a processed version of a given audio signal, wherein the bit-rate reduced representation has a format associated with a pre-defined audio encoding process, wherein the first neural network system is conditioned by a representation of the input audio signal to predict a bit-rate reduced representation of a processed input audio signal, a second neural network system trained to generate an enhanced representation of a given a bit-rate reduced audio representation, wherein the bit-rate reduced representation has a format associated with the pre-defined audio encoding process, wherein the second neural network system is conditioned by the bit-rate reduced representation predicted the first neural network system to predict an enhanced representation of the processed audio signal, and a processing stage for transforming the enhanced representation of the processed audio signal into an output audio signal.

### BRIEF DESCRIPTION OF THE DRAWINGS

The present invention will be described in more detail with reference to the appended drawings, showing currently preferred embodiments of the invention.

FIG. 1 is a block diagram of a process according to an embodiment of the present invention.

FIG. 2 shows training of the neural network systems in FIG. 1, with separate training objectives for the first stage (S1) and for the second stage (S2).

FIG. 3 is an example of a more detailed implementation of the process in FIG. 1, operating in the MDCT domain.

FIG. 4 shows a first example of the audio coding process in FIG. 2.

FIG. 5 shows a second example of the audio coding process in FIG. 2.

### DETAILED DESCRIPTION OF CURRENTLY PREFERRED EMBODIMENTS

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (i.e. a computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected. e.g., networked to other processor(s). Such a network may be built on various different network protocols, and may be the Internet, a Wide Area Network (WAN), a Local Area Network (LAN), or any combination thereof

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

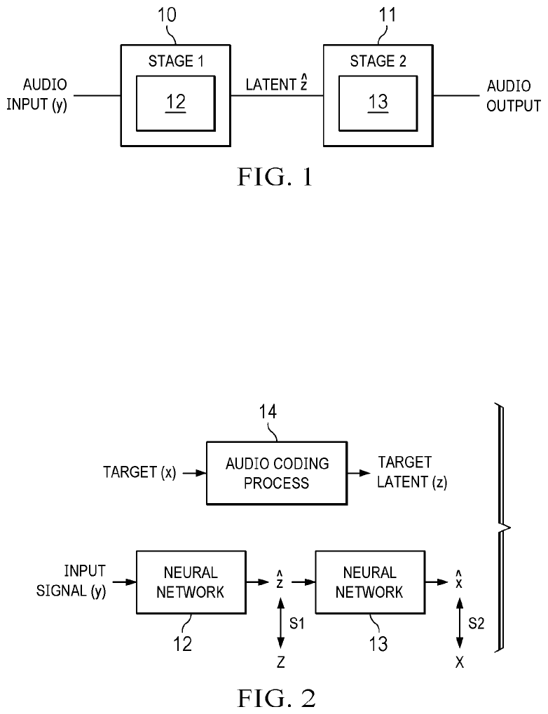

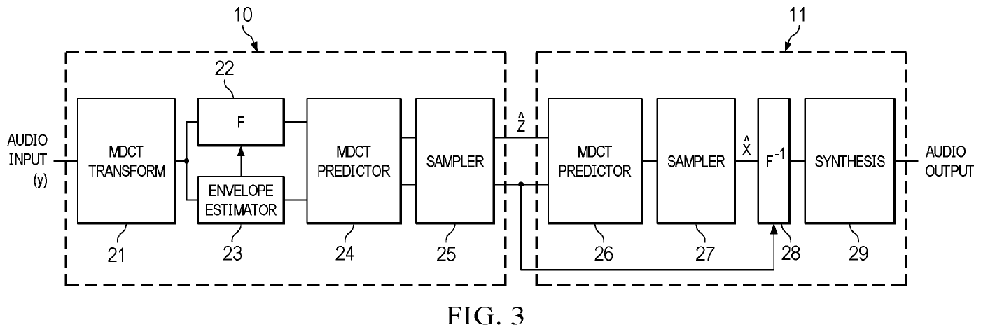

FIG. 1 shows audio signal processing of an input signal y in a two-stage architecture with a latent signal associated with a finite bitrate. The architecture has two separate processing stages 10 and 11. The first stage involves a first neural network system 12 trained to generate the latent signal \hat{z} according to a training objective (S1) for the first stage (see FIG. 2), given a representation of the input signal y. The generated latent signal \hat{z} is a prediction of a bit-rate reduced representation z of a processed input signal (denoted as target signal x in FIG. 2). The bit-rate reduced representation z (and thus also the predicted latent signal \hat{z}) has a format associated with a pre-defined audio codec, quantized to a desired bit-rate. The nature of the processing predicted by the neural network system depends on the implementation. Examples include signal separation (e.g. separating piano from a mixture music signal) and signal enhancement (e.g. speech dereverberation).

The second stage involves a second neural network system 13 trained to predict an enhanced representation \hat{x} of the predicted bit-rate reduced representation \hat{z} of the processed input signal. In other words, this stage can be considered as a reconstruction of the processed signal \hat{x} given a quantized representation \hat{z}. The enhanced representation may have the same format as the bit-rate reduced representation, but may also be different. For example, the bit-rate reduced representation may be represented in another domain (e.g., MDCT) by transforming a reconstruction of the bit-rate reduced representation.

The neural network systems 12, 13 included in stage 10 and stage 11 may be designed to operate entirely in the domain of the latent signal, e.g. in a transform domain such as MDCT. In this case the input signal is first transformed into this domain, and the prediction of the second neural network is inverse transformed back (synthesized) to the time domain.

FIG. 2 shows training of the neural network systems 12 and 13 in FIG. 1. For the training (in case of supervised training), an original audio signal y (signal to be processed) and a target signal x (processed signal) is obtained. The original signal may be e.g. a mixed piece of music including piano, and the target signal may be the same piano as an isolated signal. Further, a target latent signal z is obtained by applying the pre-defined audio coding process 14 to the target signal x (the isolated piano signal), with an appropriate degree of bit-rate reduction (quantization). The target latent signal z is a bit-rate reduced representation of the target signal x. The first neural network system 12 is trained using a representation of the original signal y to generate a latent signal \hat{z} with a first loss function S1 with respect to the target latent signal z. The first neural network system may be trained in a regression setting, in which case the loss function S1 may be a weighted square error, a Weighted L-1 norm, a Multi-resolution STFT loss, or a combination of L-2 and L-1 norms. Alternatively, the first neural network is trained in a generation setting, in which case the loss function S1 may be a negative log-likelihood (NLL). The second neural network system 13 is trained using the generated latent signal \hat{z} (in case of joint training) or the actual latent signal z (in case of independent training), to generate an output signal & with a second loss function S2 with respect to the target signal x. The second neural network system is trained in a generation setting, where the loss function S2 may be a negative log-likelihood (NLL). The training of the network systems can be done separately or in combination.

A specific implementation of the system in figure I will be described in more detail with reference to FIG. 3. In this example, the audio codec format is in the transform domain, and more specifically an MDCT domain. Both neural network systems are also designed to operate entirely in the MDCT domain. In the illustrated example, the MDCT lines are dynamics-reduced (e.g., spectrally flattened).

With reference to FIG. 3, the first stage 10 here includes an MDCT transform 21 to transform the input audio signal into the MDCT domain. The resulting MDCT lines are supplied to an envelope estimator 23 to provide a spectral envelope. The MDCT lines are then flattened by a flattening function 22 using the spectral envelope determined by the envelope estimator 23 to reduce the spectral dynamics of the signal. In some embodiments, the flattening function 22 may be implemented by estimating the spectral envelope (e.g., computing the variance of the signal in a predefined number of sub-bands), and then normalizing the MDCT coefficients in the respective sub-bands according to the value of the spectral envelope for these bands. Examples of such normalization include a normalization towards unit variance (where we use the envelope values with an exponent 1.0), or normalization towards “pink domain” (where we use the envelope values with exponent 0.5).

The resulting representation of the input signal (flattened MDCT lines and envelope) is input to a first neural network system 24. In the illustrated case, the first neural network system 24 is configured according to a generation setting and predicts a probability distribution of a latent signal \hat{z} which is sampled by sampler 25 to obtain the latent signal \hat{z}. In some embodiments, the first neural network system is instead configured according to a regression setting. The system will then provide the latent signal \hat{z} directly and the sampler 25 will not be required.

The second stage 11 here includes a second neural network system 26, operating in generative setting, which takes the latent signal \hat{z} and predicts a probability distribution of an enhanced (reconstructed) signal \hat{x}. The probability distribution is sampled by sampler 27 to obtain the enhanced signal representation \hat{x}. Just like the latent signal \hat{z}, the enhanced signal representation \hat{x} includes flattened MDCT lines and an envelope. However, the enhanced signal representation \hat{x} has higher bit-rate than the latent \hat{z}. In other words, the second neural network system 26 is conditioned by a quantized (bit-rate reduced) latent signal \hat{z} and predicts the enhanced signal \hat{x}. The enhanced signal representation \hat{x} is inverse flattened (using the spectral envelope included in the latent \hat{z}) by an inverse flattening function 28, and the audio output x is finally synthesized by an inverse MDCT transform 29.

If S1 is configured according to negative log likelihood (NLL) loss (generation setting), the first stage will provide probability distribution at its output. In order to use this as conditioning for the second stage a sampler 25 must be used. If S1 is configured in regression setting, the output of stage 1 is deterministic, and thus sampler 25 may be omitted. The S2 objective for the second stage is always configured in generation setting (according to the NLL loss), and sampler 27 would always be used.

In the process in FIG. 3, where the transform domain is MDCT, the neural network systems 24 and 26 may be designed in accordance with the topology discussed in PCT/US2021/054617, titled “GENERAL MEDIA NEURAL NETWORK PREDICTOR AND A GENERATIVE MODEL INCLUDING SUCH A PREDICTOR”, herewith incorporated by reference. In this topology, the neural network system includes a distinct frequency predicting portion and a distinct time predicting portion, wherein the output from one portion is provided as input to the other.

It is noted, however, that the neural network system in PCT/US2021/054617 is conditioned by samples of MDCT lines and generates samples MDCT lines. In the context of the process in FIG. 3, the first neural network system 24 will be conditioned by, and will predict not only the MDCT lines but also the envelope (variance vector) of the MDCT lines. The topology in PCT/US2021/054617 will therefore need to be modified in an appropriate manner, with respect to the second neural network system 26, it is noted that the envelope of the enhanced signal representation \hat{x} will be the same as the envelope of the latent \hat{z}. Therefore, the neural network system 26 may be conditioned only by the MDCT lines of the latent signal \hat{z}, and generate only the MDCT lines of the enhanced signal representation \hat{x}. The neural network system 26 may thus substantially be an implementation of the topology in PCT/US2021/054617.

For the process in FIG. 3, the training of the neural network systems will require a target latent signal z acquired using an audio coding process operating in the MDCT domain.

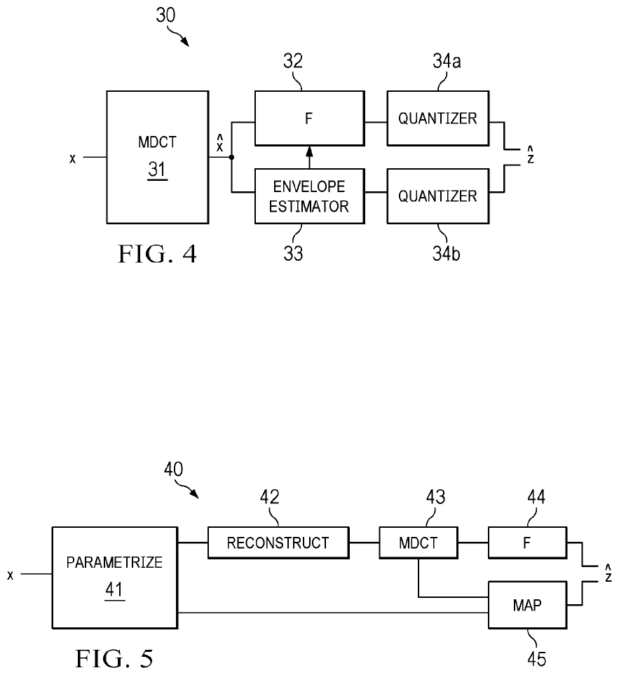

FIG. 4 shows an example of an audio coding process 30 that maps the input signal onto a bitrate reduced representation by means of quantization using a waveform codec. In the illustrated case the process 30 includes an MDCT transform 31 to transform the target signal into the MDCT domain. The MDCT transform 31 is configured to provide a perceptually motivated partitioning of MDCT lines, where lower frequency bands are more narrow (i.e. information is denser). The process further includes an envelope estimator 33 for determining a spectral envelope, and a flattening function 32 to reduce the dynamics of the MDCT lines using the spectral envelope. Finally, two quantizers 34a, 34b are provided for quantizing the flattened MDCT lines and the envelope to a desired bit-rate R. The quantizers are configured to distribute the distortion caused by a given bit-rate reduction in a perceptually optimal way (i.e. to be as little noticeable as possible). Existing audio codec processes include such quantizing algorithms.

FIG. 5 shows another example of a coding process 40 which maps the input signal onto a bitrate reduced representation by means of parametric coding. Such a coding process could be based on a sinusoidal analysis algorithm (for example, a matching pursuit algorithm), where the analysis is done in a way, where the sinusoidal components are selected to minimize some perceptual criterion (for example, spectrally weighted mean squared error). The process 40 includes a parametrizing function 41 which parametrizes the input signal to a parametric description with N sinusoids and one phase parameter per sinusoidal trajectory. The size of the number N determines the level of quantization. The larger the N, the higher will be the associated bitrate and the higher will be the fidelity of the reconstruction. In the illustrated example, the parametric description is extended with envelope information. The spectral envelope may comprise a set of envelope values associated with some frequency partition (using perceptually motivated banding). In some embodiments, the spectral envelope may be described by means of Linear Prediction Coefficients (LPC).

For use in a process shown in FIG. 3, the target latent z needs to be in the MDCT domain. For this purpose, the coding process 40 here further includes a reconstruction block 42, for reconstructing a time domain signal, and an MDCT transform 43 for obtaining MDCT lines. In principle, the parametric representation could also be reconstructed directly into MDCT domain, e.g., by projecting the sinusoids on MDCT basis. Similar to the coding process in FIG. 4, the MDCT lines are flattened by a flattening function 44 using a spectral envelope. The spectral envelope is obtained in block 45, by mapping the envelope information in the parametric description onto the MDCT lines.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

The person skilled in the art realizes that the present invention by no means is limited to the preferred embodiments described above. On the contrary, many modifications and variations are possible within the scope of the appended claims. For example, other domains than MDCT may be considered.
The invention can be further understood from the following list of enumerated exemplary embodiments (EEEs).
EEE1. A method for processing an input audio signal, comprising:
conditioning a first neural network system with a representation of the input audio signal to predict a bit-rate reduced representation of a processed input audio signal, said first neural network system being trained to generate a bit-rate reduced representation of a processed version of a given audio signal, wherein said bit-rate reduced representation has a format associated with a pre-defined audio encoding process,

conditioning a second neural network system with said bit-rate reduced representation to predict an enhanced representation of said processed audio signal, said second neural network system being trained to generate an enhanced representation of a given a bit-rate reduced audio representation, wherein said bit-rate reduced representation has a format associated with said pre-defined audio encoding process, and

transforming said enhanced representation of said processed audio signal into an output audio signal.
EEE2. The method according to EEE1, wherein the input audio signal and the output audio signal are in time domain.
EEE3. The method according to EEE1 or EEE2, wherein said enhanced representation has a format associated with said pre-defined audio encoding process.
EEE4. The method according to any one of EEE1 to EEE3, wherein the representation of the input signal, the bit-rate reduced representation, and the enhanced representation, are all in one same transform domain.
EEE5. The method according to any one of EEE1 to EEE4, wherein the transform domain is a waveform transform domain.
EEE6. The method according to any one of EEE1 to EEE5, wherein the representation of the input signal, the bit-rate reduced representation, and the enhanced representation all include a set of MDCT lines and associated envelope information.
EEE7. The method according to any one of EEE1 to EEE6, wherein the MDCT lines have reduced signal dynamics.
EEE8. The method according to any one of EEE1 to EEE7, wherein the step of transforming includes increasing signal dynamics of the enhanced representation.
EEE9. The method according to any one of EEE1 to EEE8, wherein the first neural network system is trained and operates in a generative setting.
EEE10. The method according to any one of the preceding EEEs, wherein the second neural network system is trained and operates in a generative setting.
EEE11. The method according to any one of the preceding EEEs, wherein said input audio signal is a distorted audio signal, and said first neural network system predicts a bit-rate reduced representation of a signal enhanced version of the input audio signal.
EEE12. The method according to any one of the preceding EEEs, wherein said input audio signal is a mixture audio signal, and said first neural network system predicts a bit-rate reduced representation of a source-separated version of the input audio signal.
EEE13. A system for processing an input audio signal, comprising:
a first neural network system trained to generate a bit-rate reduced representation of a processed version of a given audio signal, wherein said bit-rate reduced representation has a format associated with a pre-defined audio encoding process, wherein said first neural network system is conditioned by a representation of the input audio signal to predict a bit-rate reduced representation of a processed input audio signal.

a second neural network system trained to generate an enhanced representation of a given a bit-rate reduced audio representation, wherein said bit-rate reduced representation has a format associated with said pre-defined audio encoding process, wherein said second neural network system is conditioned by said bit-rate reduced representation predicted the first neural network system to predict an enhanced representation of said processed audio signal, and

a processing stage for transforming said enhanced representation of said processed audio signal into an output audio signal.
EEE14. The system according to EEE13, wherein the input audio signal and the output audio signal are in time domain.
EEE15. The system according to EEE13 or EEE14, wherein said enhanced representation has a format associated with said pre-defined audio encoding process.
EEE16. The system according to any one of EEE13 to EEE15, wherein the representation of the input signal, the bit-rate reduced representation, and the enhanced representation, are all in one same transform domain.
EEE17. The system according to any one of EEE13 to EEE16, wherein the transform domain is a waveform transform domain.
EEE18. The system according to any one of EEE13 to EEE17, wherein the representation of the input signal, the bit-rate reduced representation, and the enhanced representation all include a set of MDCT lines and associated envelope information.
EEE19. The system according to any one of EEE13 to EEE18, wherein the MDCT lines have reduced signal dynamics.
EEE20. The system according to any one of EEE13 to EEE19, wherein the step of transforming includes increasing signal dynamics of the enhanced representation.
EEE21. The system according to any one of EEE13 to EEE20, wherein the first neural network system is trained and operates in a generative setting.
EEE22. The system according to any one of EEE13 to EEE21, wherein the second neural network system is trained and operates in a generative setting.
EEE23. The system according to any one of EEE13 to EEE22, wherein said input audio signal is a distorted audio signal, and said first neural network system predicts a bit-rate reduced representation of a signal enhanced version of the input audio signal.
EEE24. The system according to any one of EEE13 to EEE23, wherein said input audio signal is a mixture audio signal, and said first neural network system predicts a bit-rate reduced representation of a source-separated version of the input audio signal.
EEE25. A computer program product comprising computer program code portions configured to perform the method according to one of EEE1 to EEE12 when executed on a computer processor.

1. A method for processing an input audio signal, comprising:
conditioning a first processing stage comprising a first neural network system with a representation of the input audio signal to generate a latent signal comprising a prediction of a bit-rate reduced representation of a processed version of the input audio signal, said first neural network system being trained to generate a bit-rate reduced representation of a target processed version of a given audio signal, wherein said bit-rate reduced representation has a format associated with a pre-defined audio codec quantized to a desired bit-rate,
conditioning a second processing stage comprising a second neural network system with said latent signal to predict said processed version of the input audio signal, said second neural network system being trained to generate an enhanced representation of a given bit-rate reduced audio representation of a processed version of an audio signal, wherein said bit-rate reduced representation has a format associated with said pre-defined audio codec, and
transforming said predicted processed version of the input audio signal into an output audio signal.

2. The method according to claim 1, wherein the input audio signal and the output audio signal are in time domain.

3. The method according to claim 1, wherein said enhanced representation has a format associated with said pre-defined audio encoding process.

4. The method according to claim 1, wherein the representation of the input signal, the bit-rate reduced representation, and the enhanced representation, are all in a same transform domain.

5. The method according to claim 1, wherein the transform domain is a waveform transform domain.

6. The method according to claim 1, wherein the representation of the input signal, the bit-rate reduced representation, and the enhanced representation all include a set of MDCT lines and associated envelope information.

7. The method according to claim 6, wherein the MDCT lines have reduced signal dynamics.

8. The method according to claim 1, wherein the step of transforming includes increasing signal dynamics of the enhanced representation.

9. The method according to claim 1, wherein the first neural network system or the second neural network system is trained and operates in a generative setting.

10. (canceled)

11. The method according to claim 1, wherein said input audio signal is a distorted audio signal, and said first neural network system predicts a bit-rate reduced representation of a signal enhanced version of the input audio signal or wherein said input audio signal is a mixture audio signal, and said first neural network system predicts a bit-rate reduced representation of a source-separated version of the input audio signal.

12. (canceled)

13. A system for processing an input audio signal, comprising:
a first processing stage comprising a first neural network system trained to generate a bit-rate reduced representation of a target processed version of a given audio signal, wherein said bit-rate reduced representation has a format associated with a pre-defined audio codec quantized to a desired bit-rate, wherein said first neural network system is conditioned by a representation of the input audio signal to generate a latent signal comprising a prediction of a bit-rate reduced representation of a processed version of the input audio signal,
a second processing stage comprising a second neural network system trained to generate an enhanced representation of a given bit-rate reduced audio representation of a processed version of an audio signal, wherein said bit-rate reduced representation has a format associated with said pre-defined audio codec, wherein said second neural network system is conditioned by said latent signal predicted at the first neural network system to predict said processed version of the input audio signal, and
a processing stage for transforming said predicted processed version of the input audio signal into an output audio signal.

14. The system according to claim 13, wherein the input audio signal and the output audio signal are in time domain.

15. The system according to claim 13, wherein said enhanced representation has a format associated with said pre-defined audio codec.

16. The system according to claim 13, wherein the representation of the input signal, the bit-rate reduced representation, and the enhanced representation, are all in a same transform domain.

17. The system according to claim 13, wherein the transform domain is a waveform transform domain.

18. The system according to claim 13, wherein the representation of the input signal, the bit-rate reduced representation, and the enhanced representation all include a set of MDCT lines and associated envelope information.

19. The system according to claim 18, wherein the MDCT lines have reduced signal dynamics.

20. The system according to claim 13, wherein the step of transforming includes increasing signal dynamics of the enhanced representation.

21. The system according to claim 13, wherein the first neural network system or the second neural network system is trained and operates in a generative setting.

22. (canceled)

23. The system according to claim 13, wherein said input audio signal is a distorted audio signal, and said first neural network system predicts a bit-rate reduced representation of a signal enhanced version of the input audio signal or wherein said input audio signal is a mixture audio signal, and said first neural network system predicts a bit-rate reduced representation of a source-separated version of the input audio signal.

24. (canceled)

25. A computer program product comprising computer program code portions configured to perform the method according to claim 1 when executed on a computer processor.
